(19) United States
(12) Patent Application Publication
(10) Pub. No.: US 2010/0050080 A1
(43) Pub. Date: Feb. 25, 2010

(54) SYSTEMS AND METHODS FOR SPECIFYING FRAME-ACCURATE IMAGES FOR MEDIA ASSET MANAGEMENT

(76) Inventors: Scott Allan Libert, Tigard, OR (US); James Edward Pearce, Silchester (GB)

Correspondence Address: Robert D. Shedd, Patent Operations;THOMSON Licensing LLC, P.O. Box 5312, Princeton, NJ, 08543-5312, US

(21) Appl. No.: 12/450,406

(22) PCT Filed: Mar. 20, 2008
(86) PCT No.: PCT/US2008/003656

§ 371 Date: Sep. 24, 2009

Related U.S. Application Data
(60) Provisional application No. 60/923,427, filed on Apr. 13, 2007.

(51) Int. Cl. G06F 3/048

(52) U.S. Cl. 715/716; 715/769; 715/838

(57) ABSTRACT

A system for managing media assets includes a media content analysis system to extract metadata from a media asset and generate low-resolution media content objects representative of a media asset including frame-accurate thumbnail images of one or more frames of a video file, a media asset storage system to store metadata and low resolution media content objects in association with corresponding media assets; and a media asset managing system to access and manage media assets stored in the media asset storage system. The media asset managing system includes a metadata view renderer to render a metadata user interface that displays metadata associated with a media asset and allows user manipulation and editing of the metadata, wherein the metadata user interface displays a thumbnail image that is representative of the media asset, a storyboard view renderer to render a storyboard user interface that displays a sequence of thumbnail images of selected frames of the media asset and allows user manipulation and editing of the storyboard; a clip player view renderer to render a clip player user interface that allows a user to play and manipulate a frame-accurate low-resolution proxy of the media asset; and a view controller to control communication between the metadata, storyboard and clip player view renders such that user actions in manipulating and editing a media assets in one graphical user interface is synchronized over all views.

### CROSS-REFERENCE TO RELATED APPLICATION

This application claims priority to U.S. Provisional Application No. 60/923,427, filed on Apr. 13, 2007, which is incorporated herein by reference for all purposes.

### TECHNICAL FIELD

The present disclosure relates generally to systems and methods for managing media assets and, in particular, media asset management systems and methods implementing a user-interface that supports user specification of frame-accurate thumbnail images to represent either a “point of interest” in a storyboard or a thumbnail display for multimedia assets.

### BACKGROUND

Technological innovations in communications and multimedia computing technologies has resulted in the increase in the amount of multimedia content that is available for access over communication networks for use in various applications including, for example, educational, scientific, commercial and entertainment applications. As the amount of multimedia content continues to increase, it becomes increasingly difficult to efficiently search and manage digital media assets. In this regard, media asset management systems are important tools that allow individuals to collect, store, organize, and otherwise manage media assets. In general, media asset management systems allow users to attach descriptive metadata to digital media assets such as video data, which describes the content of the media, or other related information pertaining to the media.

For example, media assets comprising video or still images can be annotated using “thumbnails” and “storyboards.” Thumbnails are small representations of actual images, videos, or other media files in the system, which are created from an image or video frame with lower resolution and size. Thumbnails are useful visual representations for video content. Moreover, video content can be represented by a storyboard of annotated still images representing each scene within the video clip. A storyboard can be used as a means of quickly reviewing video content in a faster-than real-time manner. Typically, intelligent scene-detection algorithms are used to automatically select representative thumbnails and select a set of thumbnails to create storyboards. For video assets, a default thumbnail that is selected to represent a video file can be the first non-black frame of the video. For storyboards, the default set of thumbnail images can be a collection of the first video frame of each shot. However, depending on the type of the content, the automated thumbnail selection process may not be as accurate as one would like and the selected thumbnails may not be representative of the asset's content. In conventional asset management schemes, no functionality is present to allow users to change the automated selected thumbnails for media assets, although it would be useful to allow users to add thumbnails to and/or remove thumbnails from a storyboard.

### SUMMARY

Exemplary embodiments according to the present principles generally include systems and methods for managing media assets and, in particular, media asset management systems and methods implementing a user-interface that supports user specification of frame-accurate thumbnail images to represent either a “point of interest” in a storyboard or a thumbnail display for multimedia assets.

In one exemplary embodiment, a system for managing media assets includes a media content analysis system to extract metadata from a media asset and generate low-resolution media content objects representative of a media asset including frame-accurate thumbnail images of one or more frames of a video file, a media asset storage system to store metadata and low resolution media content objects in association with corresponding media assets; and a media asset managing system to access and manage media assets stored in the media asset storage system. The media asset managing system includes a metadata view renderer to render a metadata user interface that displays metadata associated with a media asset and allows user manipulation and editing of the metadata, wherein the metadata user interface displays a thumbnail image that is representative of the media asset, a storyboard view renderer to render a storyboard user interface that displays a sequence of thumbnail images of selected frames of the media asset and allows user manipulation and editing of the storyboard; a clip player view renderer to render a clip player user interface that allows a user to play and manipulate a frame-accurate low-resolution proxy of the media asset; and a view controller to control communication between the metadata, storyboard and clip player view renders such that user actions in manipulating and editing a media assets in one graphical user interface is synchronized over all views.

In another exemplary embodiment, the metadata view renderer is configured to render a metadata user interface that allows a user to navigate between a thumbnail view, a keyword metadata view and a custom metadata view. The keyword metadata view can display a list of keywords that are associated with one or more segments of a video media asset, wherein a duration of each segment is defined by the difference in the timecode metadata for mark-in and mark-out frames associated with the keyword. The clip player user interface can be rendered to have mark in and mark out buttons that allow a user to select starting and ending frames of a clip segment, respectively, during a playback of a low-resolution proxy clip to add a new keyword which is rendered to presentation to a user in the keyword metadata view. The starting frame of a clip segment can be user-selectable by selecting and dragging a first image frame displayed on the clip player user interface and dropping the selected first image frame onto the mark in button, and wherein the ending frame of a clip segment is selectable by a user by selecting and dragging a second image frame displayed on the clip player user interface and dropping the selected second image frame onto the mark out button.

In another exemplary embodiment, the thumbnail images of a media asset displayed on the storyboard user interface are graphical objects that can be selected and dragged to a thumbnail icon region of the metadata user interface and dropped on the thumbnail icon region to change the thumbnail icon off the media asset to the selected storyboard image.

In another exemplary embodiment, the thumbnail images of a media asset displayed on the storyboard user interface are graphical objects that can be selected to initiate the playing of a low resolution proxy video of the media asset at the frame associated with the selected storyboard thumbnail image.

In another exemplary embodiment, the thumbnail images of a media asset displayed on the storyboard user interface can be modified by selecting and dragging a video frame displayed by the clip player user interface to the storyboard user interface and dropping the selected video frame onto the displayed storyboard.

These and other exemplary embodiments, aspects, features, and advantages of the present invention will become apparent from the following detailed description of the preferred embodiments, which is to be read in connection with the accompanying drawings.

### BRIEF DESCRIPTION OF THE DRAWINGS

FIG. 1 is a block diagram illustrates a multimedia data processing system according to an exemplary embodiment of the present principles.

FIG. 2A illustrates a graphical user interface of a thumbnail metadata view according to s a graphical illustration of a thumbnail view user interface according to an exemplary embodiment of the present principles.

FIG. 2B illustrates a graphical user interface of a keyword metadata view according to an exemplary embodiment of the present principles.

FIG. 2C illustrates a graphical user interface of a custom metadata view according to an exemplary embodiment of the present principles.

FIG. 2D illustrates a graphical user interface of a custom metadata view according to an exemplary embodiment of the present principles.

FIG. 3 illustrates a graphical user interface of a storyboard view according to an exemplary embodiment of the present principles.

FIG. 4 illustrates a graphical user interface of a clip player view according to an exemplary embodiment of the present principles.

FIG. 5 illustrates a method for controlling and managing communication between the media asset views according to an exemplary embodiment of the present principles.

### DETAILED DESCRIPTION

The present invention can be implemented in various forms of hardware, software, firmware, special purpose processors, or a combination thereof. Preferably, the present invention is implemented in software as an application comprising program instructions that are tangibly embodied on one or more program storage devices (e.g., magnetic floppy disk, RAM, CD ROM, ROM, Flash memory, etc.) and executable by any device, machine or platform comprising suitable architecture. It is to be further understood that because some of the system components and method steps depicted are preferably implemented in software, the actual connections between the system components (or the process steps) can differ depending upon the manner in which the present invention is programmed.

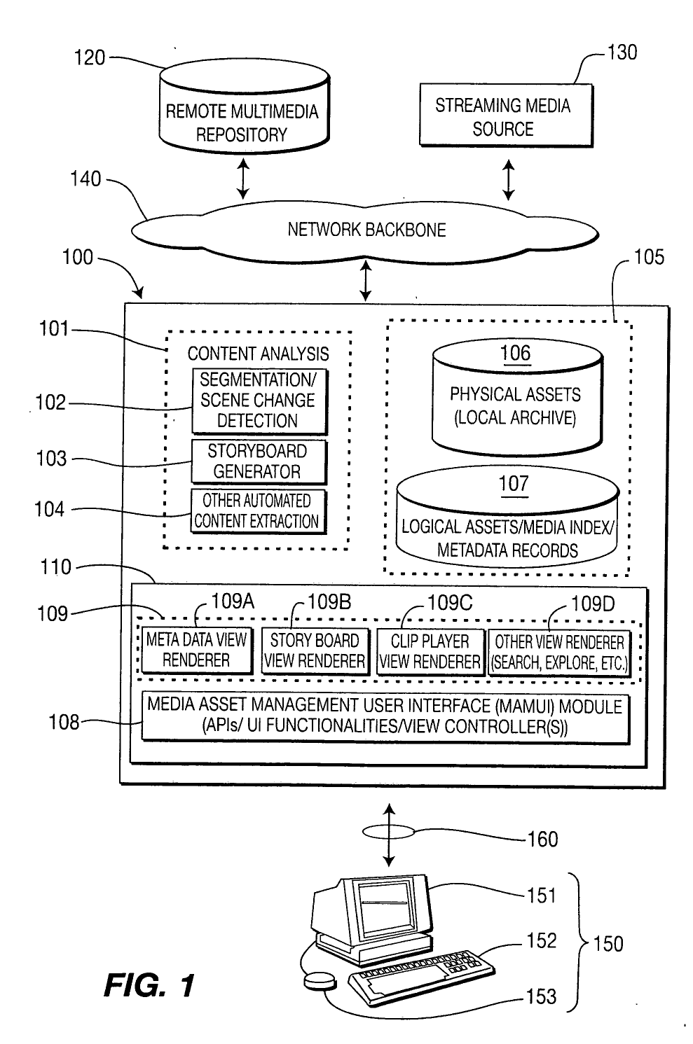

Referring to FIG. 1, a block diagram illustrates a media asset processing system (100) according to an exemplary embodiment of the present principles. In general, the media asset processing system (100) comprises a media content analysis system (101), a media asset storage system (105) and a media asset management system (110), which implement methods to support various functionalities for browsing, accessing, collecting, analyzing, indexing and otherwise managing digital media assets, as will be discussed in further detail below. FIG. 1 is an illustrative embodiment of the multimedia data processing system (100) implemented in a distributed computing environment in which the system (100) can be utilized to browse and download multimedia content from various media content sources (120) and (130) at remote locations over a communications network (140) (e.g., the Internet, an Intranet, WAN, LAN, wireless network, etc.). The media content source (120) can be a media file server that stores on-line accessible multimedia content files (e.g., MPEG video files) or a network device having a database of multimedia files (e.g., digital audio and/or video files, etc.). The media content source (130) can be a media server that generates and outputs steaming media (e.g., audio/visual news broadcast, sports event, etc.). The multimedia data processing system (100) can be a network application that is accessible through a browser-based GUI interface via a client access computing device (150) over a local area network (LAN), wide-area network (WAN), the Internet, etc. The client device (150) can be a computer workstation with a graphical user interface (display, 151, keyboard, 152, pointing device (153), or other suitable computing device. In other embodiments, the multimedia data processing system (100) can reside and execute on the client computing device (150).

In general, the content analysis system (101) implements automated methods for parsing and processing high-resolution media content (such as video files) accessed from media sources (120, 130) to extract metadata and generate low-resolution proxies of media assets that are ingested into the media asset storage system (105). The metadata is stored in metadata records that are associated with managed media assets. The media asset storage system (105) provides a local repository/database (106) to store and manage “physical assets” and a centralized repository/database (107) to store and manage “logical assets”. In particular, the logical asset repository (107) stores media assets and associated content in the form of “logical assets” and associated metadata defining logical asset attributes, wherein the logical assets are defined according to some data model/schema.

The media assets are stored as logical assets in user defined folders along with sub-folders that include various media objects and components such as low resolution video clips, audio clips, thumbnails, along with metadata records. A logical asset can be uniquely identified by a Universal Resource Name (URN), a globally unique ID. The physical asset repository (106) stores archive copies of the actual media files, or portions of medial files (e.g., subclips of a video file) that are managed in the system (100). A logical asset can include references to more than one physical asset (e.g., a media file in a remote data source (120) or (130) and an archived copy of the media file in the local repository (106). The media asset storage system (105) not only stores low-bandwidth content (proxies and thumbnails), but also operates to synchronize content across different content views and maintain metadata for browsing functions, as will be explained below.

The type of metadata that is extracted and stored in association with logical assets corresponding to manage digital media assets can vary depending on the application. For example, in the illustrative embodiment of FIG. 1, with regard to video media assets, the content analysis system (101) comprises various processing modules including a segmentation/scene change detection module (102), and a storyboard generator module (103) and other optional automated data extraction modules (104). The segmentation/scene change detection module (102) can implement known methods for segmenting video frames into “shots,” which affords an efficient method for video browsing and content based retrieval. A “shot” in video parlance refers to a contiguous recording of one or more video frames depicting a continuous action in time and space. Typically, there are transitions between shots referred to as “scene changes” or “cuts.” The scene change detection module (102) outputs or otherwise flags potential scene change locations in the video data outputs metadata representing candidate and non-candidate scene change locations (frames)

The output of the scene change detector module 102 is a list of scenes (or shots) corresponding to the input video data along with time-code meta data associated with, and directly linked to, each frame to each frame in the video asset. As is known in the art, the frames of a video sequence can be enumerated using a standard time-based system, e.g., where each frame can be identified by a time in hours, minutes, seconds and thirtieths of seconds, with video having 30 frames per second. A start time can be indicated in second fractions, seconds, minutes and hours. The storyboard generator (103) receives the segmented video data and automatically generates storyboard comprising a set of “thumbnail” images of frames that are representative of each shot. The storyboard generator (103) will storyboard a video clip based upon scene changes and automatically extract appropriate frame images along with the appropriate time-code metadata, and store one or more thumbnail images (low resolution media content) with the video asset.

The content extraction module (104) can be implemented to automatically extract other types of data from media files to provide other forms of descriptive metadata that describes the content media file in order to provide a more meaningful database of information to search. For instance, some methods can be implemented for analyzing closed captioning information, or performing audio to text conversion for extracting keywords and phrases representative of media content. Other encoding methods can be provide for automatically generating low-resolution proxy video of high-resolution media upon ingestion into the system (100) to be stored in the database (107). The extracted metadata and low-bandwidth proxies (video proxies, thumbnails, etc.) are stored together with metadata that remains linked to the assets with the global ID in database (107). The creation and management of these assets is performed in such a way that the low-resolution assets, hi-resolution assets, and global metadata are always synchronous and frame accurate.

The media asset management system (110) implements methods for browsing the centralized database (107), previewing media assets using a plurality of synchronized views, and editing and manipulating media assets. As explained below, such tools allows users to search and organize content, and add user-definable metadata, frame-accurate location and video editing, and the ability to select frames in a video asset as party of thumbnail representation or part of a storyboards, and the ability to mark “in” and “out” points of clips. The media asset management system (110) includes a MAMUI (media asset management user interface) module (108) and a plurality of view renderers (109). The view renderers (109) generally include a metadata (thumbnail) view renderer (109A), a storyboard view renderer (109B), a clip player view renderer (109C) and other view renderers (109D). The MAMUI module (108) comprises application program interfaces (API) and methods and controllers for enabling user access and interaction with media assets, as well as other functions for controlling execution of the application flow and dialog. The various view renderer modules provide the means of display of information to the user, or to query information from the user, while the controllers manage communication between the views.

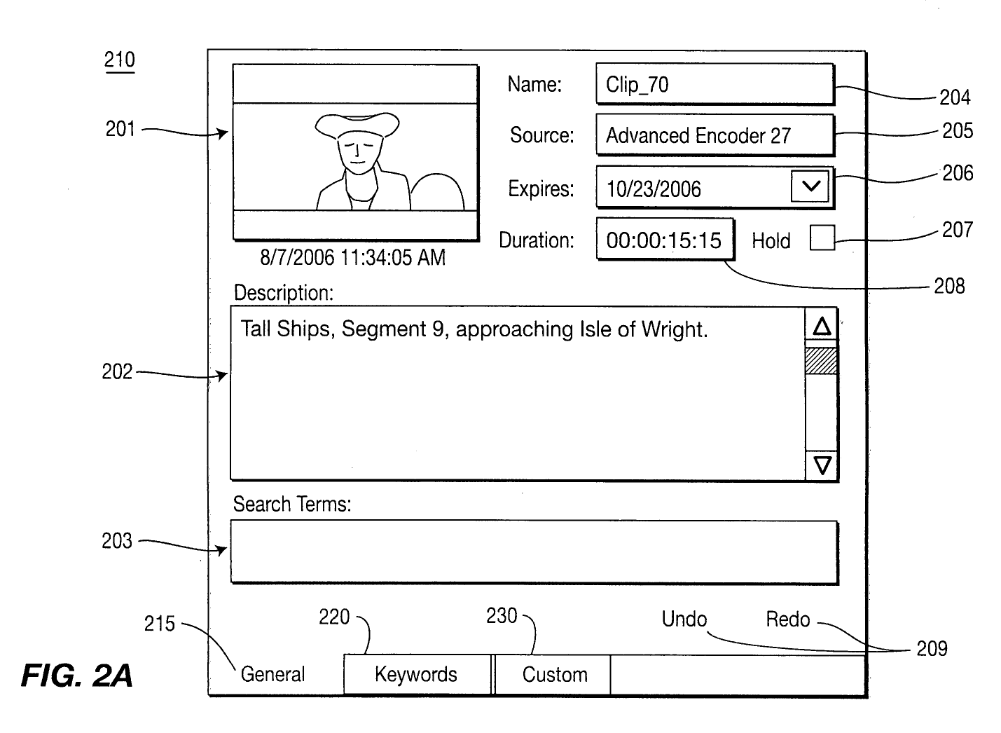

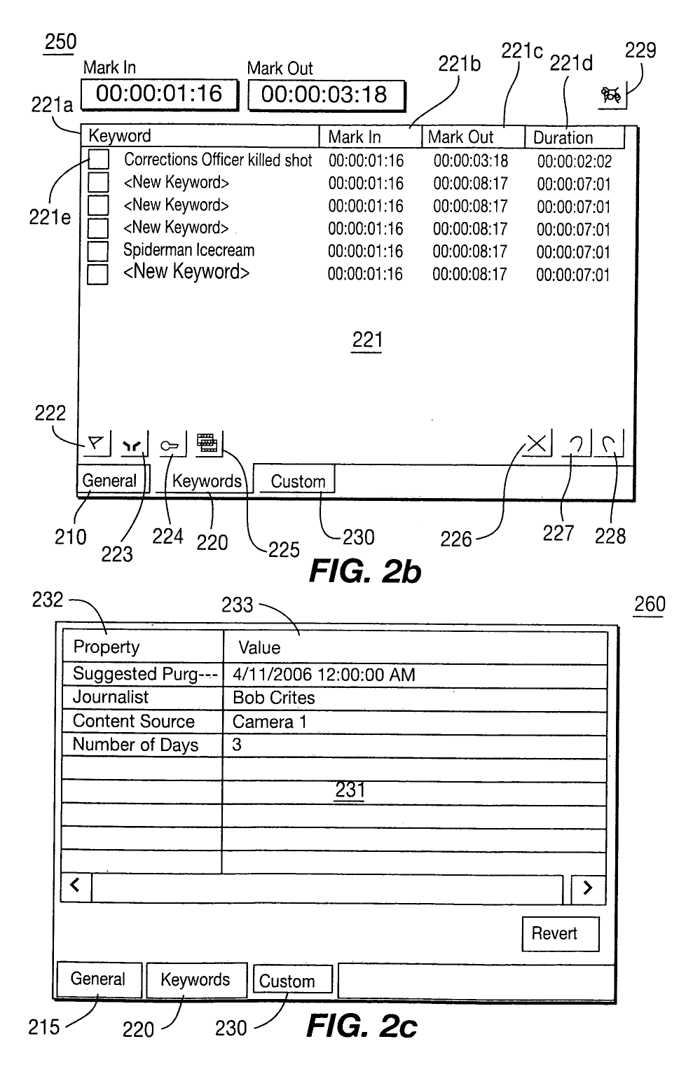

For instance, a search View provides the ability to search the databases (106) and (107), wherein searches on the (107) return Logical Assets, whereas searches on database (106) return Physical Assets. The metadata view renderer (109A) can be invoked to render a graphical user interface for displaying metadata associated with a media asset of interest. For instance, as will be discussed in further detail below, FIGS. 2A˜2C are exemplary graphical user interface displays that can be generated and displayed by the metadata view renderer (109A) including a core “General Metadata” view (210), a “Keywords” view (220) and “Custom Metadata” view (230) to access and manage media assets. The storyboard view renderer (109B) can be invoked to render a graphical user interface for displaying a storyboard associated with a media asset of interest, such as will be discussed with reference to FIG. 3, for example. The Clip Player View render (109C) can be invoked to render a graphical user interface for displaying a clip player view that provides users the ability to play a frame-accurate low-resolution version of the asset.

The various rendering modules (109) are tightly integrated to support drag and drop operations and right-click context menus as described below so that metadata content and views of the media files can be manually edited/modified by a user via UI functions. For instance, as described below the Metadata View user interface, among other things, contains a representative thumbnail for a media asset, where user interactive functional allows a user to change this thumbnail from its default value to any other valid video frame within the asset. The Storyboard View user interface displays all thumbnail images within an asset's storyboard and allows a user to modify the thumbnail images comprising a storyboard view of the asset. The Clip Player View user interface plays a frame-accurate low-resolution version of the asset, while allowing a user to select a desired video frame to be dragged and dropped to its destination in another view so that when the image is dropped, the thumbnail or storyboard is modified, for example. While the user is dragging the image, the image is “attached” to the cursor and is displayed in a semi-transparent fashion in order that the user can also see what is currently “underneath” the image.

Metadata View

The metadata view renderer (109A) can be invoked to render a graphical user interface for displaying and manipulating metadata associated with a media asset of interest. For instance, FIGS. 2A˜2D are exemplary graphical user interface displays that can be generated and displayed by the metadata view renderer (109A) including a core “General Metadata” view (210), a “Keywords” view (220) and “Custom Metadata” view (230) to access and manage media assets.

For example, FIG. 2A is an exemplary graphical user interface for the general metadata view (210) which essentially provides a “thumbnail: view for the associated media asset. Specifically, the GUI (210) includes thumbnail view icon (201), various data fields such as a description field (202), search terms field (203), name (204), source (205), expiration (206) and duration (207) fields that display various metadata attributes associated with a given asset. In addition, the GUI (210) includes user selectable control buttons and tabs including hold selection (208), undo/redo buttons (209) and selection tabs (215, 220, 230) for toggling between the different metadata views “General Metadata,” “Keywords” and “Custom Metadata.”

The description field (202) allows a user to include a textual descriptive annotation of the media asset, while the search field (203) allows a user to include specific text search terms. The user can revise the metadata attributes of the various fields if the user has the appropriate privileges where the data displayed is read-write, otherwise the data is read-only. The current context can be set programmatically at any time to the URI of desired metadata record. Undo and redo buttons (209) are selectable for metadata changes. The Thumbnail (201) can be modified via drag/drop operations from the clip player or storyboard controls as discussed below.

FIG. 2B is an exemplary graphical user interface for the keyword metadata view (250). Metadata can comprise metadata items or “keywords” which can be assigned to appropriate time portions along a media timeline using a visual indicator, e.g., a graphical representation of a metadata item or graphical ‘bar’ which can be displayed on a screen. An individual graphical bar is preferably assigned to each keyword along a portion of the media timeline corresponding to the time duration during which it is applicable. Each new metadata item or “keyword” which is added results in an additional graphical bar being included in the media timeline at the keyword's appropriate temporal location.

The keyword display (250) includes a keyword list field (221) for displaying a list of one or more keywords and corresponding metadata for keywords associated with the currently selected media asset. The keyword list (221) is rendered in a columnar or table format. The table columns or metadata associated with each file include “Keyword” name (221a), “Mark In” time (221b), “Mark Out” time (221c), and “Duration” (221d), as well as small thumbnail representations (221e). Control buttons include an “add Keyframe” button (222), an “automark keyword” button (223) and add keyword button (224) a “create subclip button (225) delete (226) undo (227), redo (228) and delete all keys (229).

The keyword list (221) allows in-place editing of Keyword text, in-place editing of keyword in/out points, and setting keywords via the clip player or storyboard controls. The in/out points (221b, c) are linked to mark in and out controls in the clip player control interface. Each keyword also has a thumbnail (221e), which is displayed when in thumbnail mode. Any keyword can be deleted or amended. The create subclips control button will create subclips (using the keyword name to name the subclip) from all selected keywords. The keyword description will be used to name the newly-created subclip. Subclips will be created in the same folder as the source material. The keyword list is printable with thumbnail, description, in/out.

FIG. 2D is a graphical user interface (220-1) according to an exemplary embodiment of the present principles that can be displayed to allow a user to configure settings for automatic sub clip creation, automatic naming of keys, mark in reaction time, and auto-mark duration. When a clip is loaded, a user can use any number of hotkeys for marking clips. For instance, an “insert key” can be used to add a keyframe (a moment in time, not an in or out). If auto-naming is on, the keyword gets that name. Moreover, mark in (I key), mark out (O key), and add (Enter key), which adds a keyword. If auto-naming is on, the keyword will be assigned automatically. If “automatically create subclips” is selected, a subclip will be created. If “mark in by reaction time” is set, the mark in time will be set back n frames from the selected frame. The F4 key can be used as auto-mark feature, where if auto mark out is not set, then activation of the key does nothing. If auto-mark out is active, but not in, then the mark in is the point in time that the key got selected. If auto-mark out is on, and mark in has a reaction time, then the reaction time is taken into account prior to the duration being added. If auto-naming is on, the keyword gets the name.

When keywords are selected in the dialog, the user can delete one or more keywords using the delete key (active only when keyword(s) are selected). The user can delete all keywords by using the delete all keys button (Keyframes and Keywords). The Add Keyframe (via Insert) can always be active. The Auto-Mark Keyword may only be active if auto-mark is configured and enabled (always active if settings are enabled. The Add Keyword feature is active only when mark-in and mark-out are set The create subclip feature is active when a keyword (not keyframe) is selected in the list. Its role is diminished with automatic subclip creation, but it still has a purpose for additional subclips of the same keyword. The Undo/Redo is active when keywords are added to the list.

Custom Metadata

FIG. 2C is a custom metadata graphical user interface (260) that can be displayed when selecting tab (230) which can be used to supports wide range user-defined metadata and annotation fields of a custom metadata inclusive of metadata from source (i.e., metadata associated with stored images of a camera) if metadata mapping is performed. If a user has media manager rights, an “Add . . . ” button can be enabled, allowing dynamic addition of custom metadata fields. The graphical UI (260) includes a field (231) that displays a list of metadata proper (232)/value (233) pairs that are user defined.

### Storyboard View

FIG. 3 is an exemplary graphical user interface of a storyboard view (300). The exemplary storyboard screen (300) comprises a display field (301), a tool bar (302), scroll bar (303) and control buttons (304). In FIG. 3, the storyboard is shown to include a sequence of frames (12 frames) (i.e., essentially 12 thumbnail previews), The Storyboard View displays the contents of a media asset's storyboard object as a list of time-ordered images. Although primarily used as a secondary means to navigate through video and/or quick browse video content, the Storyboard also provides editing capabilities (allowing users to add image to/remove images from the storyboard, and to add keywords based on contiguous range of images).

The context is a URI of the media assets storyboard, wherein the temporal Reference of range to display. Each storyboard item can have a “tool tip” that will display the timecode associated with that frame of video. Each Storyboard item can be selected More than one thumbnail can be selected at any time, as long as the thumbnails are contiguous. When a storyboard item is selected, the clip player will skip to the current position of the most recently selected item in the storyboard.

Moreover, the selected storyboard items have a context menu associated with the storyboard items including a (i) Set Mark In (only valid for single selection), (ii) a set Mark Out (only valid for single selection) (iii) a Set Thumbnail to . . . (only valid for single selection), (iv) Create Keyword and (v) Delete. The user interface provides the ability to add images to the storyboard by dragging them from the clip player control. This user should be able to do this on a growing file. A “Filter Storyboard” capability is provided (accessible via an options button (304) on the storyboard window bar (302) that invokes a dialog that can “filter” the storyboard images based on a time interval. Any selected image in the storyboard can be a drag source. The clipboard data will be the range of time specified by the start time of the first selected thumbnail and the end time of the last selected thumbnail. This allows storyboard images to be used to set the thumbnail in the core metadata view. A keyframe only storyboard option can be selected that will only show keyframes in the storyboard view.

### Clip Player View

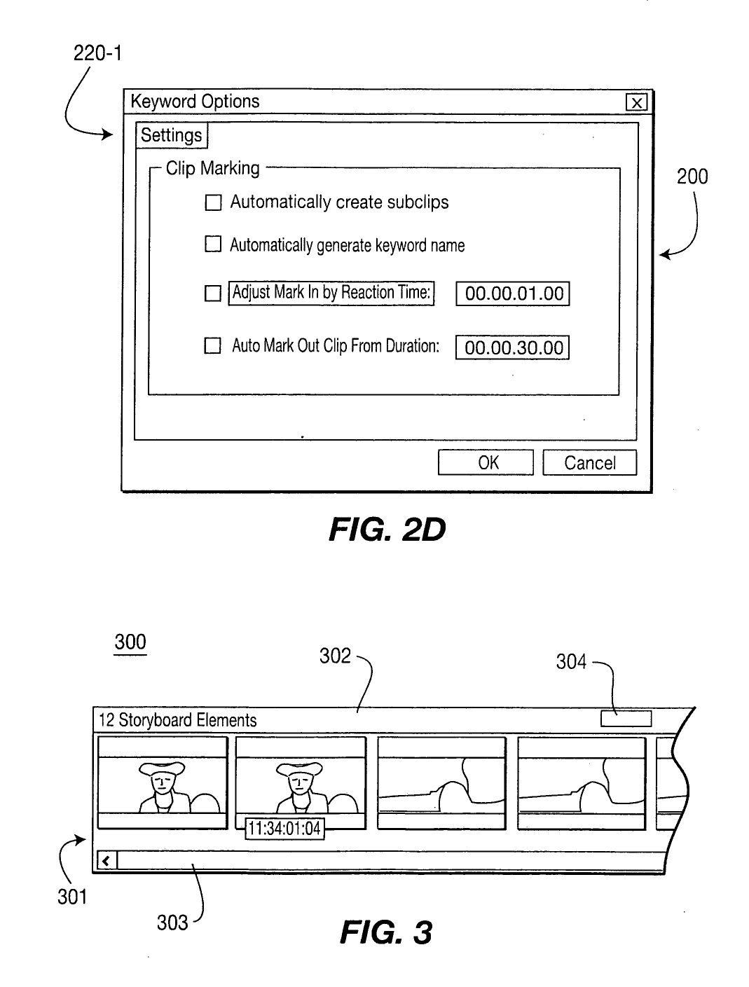

FIG. 4 is an exemplary graphical user interface of a clip player view (400) that is rendered by the clip viewer renderer module (109C). The Clip Player View provides users the ability to play a frame-accurate low-resolution version of a media asset. The current context can be set at any time to the URI of the proxy (and the URI of the associated high-resolution material) to be displayed.

The clip player view (400) includes a display window (401) to display a low bandwidth version of the media asset. The exemplary GUI (400) comprises playback controls (402˜410) including pause (405), play (406) and stop (407) buttons, rewind control buttons including fast rewind (404), n-frames rewinding (403) and single frame rewind (402) controls, fast forward (408), n-frames forwarding (409) and single frame forward (410) controls, timecode display windows (416, 417, 418), including Mark in/out timecodes and “set mark in/out” buttons (413, 414). A control (411) displays information regarding the duration not only of the low-resolution proxy, but also of the matching high-resolution material (which are not necessarily identical) and a playback speed control (415). An automatic reload button (412) is included. The “seek bar” control (411) displays the length of the low-resolution asset or the high-resolution asset (the clip paler control can be configured to view either the original source timecode or a zero based timecode). After selecting the desired video frame, the user can drag the image to its intended destination to provide “Add to Storyboard” Menu Item and “Set Thumbnail to” Menu Item

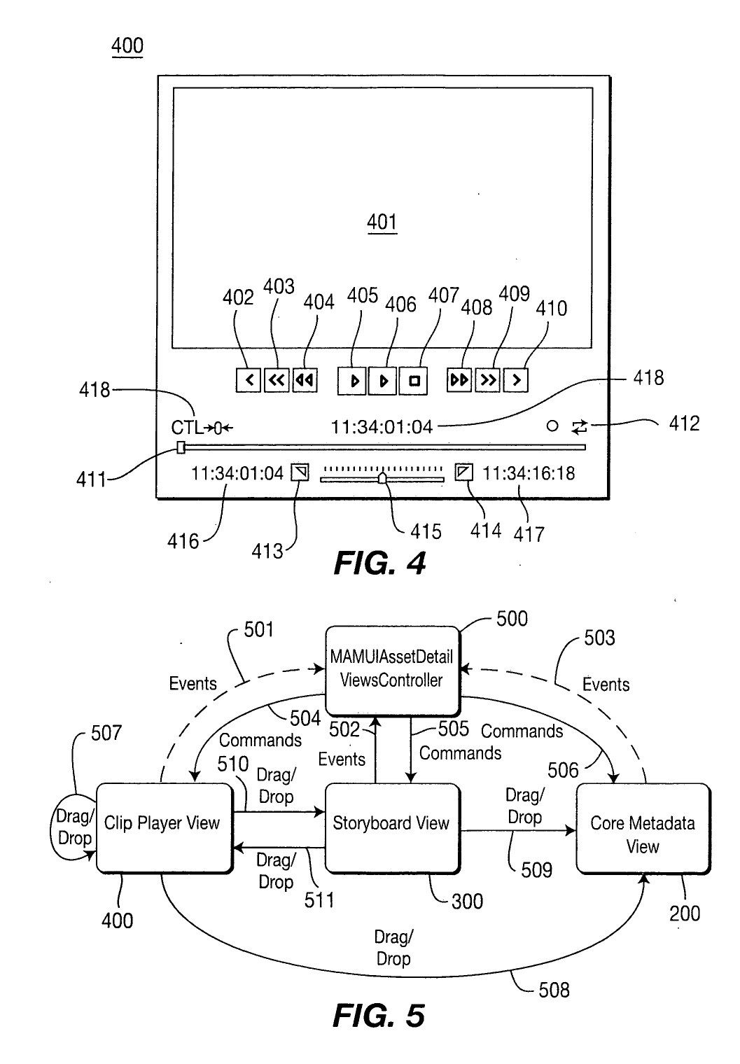

FIG. 5 is an exemplary diagram of a method for managing media assets through an integrated interactive user interface. FIG. 5 depicts a views controller (500) that operates to manage communication between the various interactive views (200, 300, and 400). As discussed above, each view renderer renders a graphical user interfaces that enable presentation and interaction with content media. The views provide the means of display of information to the user, or to query information from the user, while the controllers manage communication between the views. The controller (500) receives various events (501), (502), (503) from respective views (400), (300), and (200). A view forwards user input events (501, 502, 503) to the controller (500). The controller (500) interprets user inputs and maps them into actions to be performed and sends commands (504, 505, 506) to the views as appropriate In the Clip Player view (400), the image video time reference window (418) is a drag object that can be dropped on (i) the thumbnail picture box (201) in the core metadata view screen (FIG. 2A), or to the storyboard window in the storyboard view to the mark in control button or mark out control button of the clip player view screen. In the storyboard view screen (300), the image video time reference window is a drag object that can be dropped on (i) the thumbnail picture box in the core metadata view screen (FIG. 2A), the mark in control button or mark out control button of the clip player view screen. Alternatively, the user can right-click on a portfolio via a mouse to display a context menu of portfolio operations as discussed above. With the integrated system, when search results of a user query to the centralized media asset database (107) are returned, the user can generate appropriate commands to display and interact with the various views of the selected digital media asset, in synchronization. As such, depending on the position a user selects (for example with a mouse or other cursor control device) within a given view of the media asset, the user will begin interaction with the content of the media asset at different points in time and space, which provides more efficient and intuitive way for browsing and managing content.

Although exemplary embodiments have been described herein with reference to the accompanying drawings, it is to be understood that the present system and method is not limited to those precise embodiments, and that various other changes and modifications can be affected therein by one skilled in the art without departing from the scope or spirit of the invention. All such changes and modifications are intended to be included within the scope of the invention as defined by the appended claims.

1. A system, comprising:
a media content analysis system utilized to select a visual representation from media content; and
a media asset managing system utilized to associate the selected visual representation with a user-specified portion of the media content.

2. The system of claim 1 further comprising:
a media content analysis system that further extracts metadata from a media asset and generate low-resolution media content objects representative of a media asset including frame-accurate thumbnail images of one or more frames of a video file;
a media asset storage system to store metadata and low resolution media content objects in association with corresponding media assets; and
a media asset managing system that further accesses and manages media assets stored in the media asset storage system, wherein the media asset managing system further comprises:
a metadata view renderer to render a metadata user interface that displays metadata associated with a media asset and allows user manipulation and editing of the metadata, wherein the metadata user interface displays a thumbnail image that is representative of the media asset;
a storyboard view renderer to render a storyboard user interface that displays a sequence of thumbnail images of selected frames of the media asset and allows user manipulation and editing of the storyboard;
a clip player view renderer to render a clip player user interface that allows a user to play and manipulate a frame-accurate low-resolution proxy of the media asset; and
a view controller to control communication between the metadata, storyboard and clip player view renders such that user actions in manipulating and editing a media assets in one graphical user interface is synchronized over all views.

3. The system of claim 2, wherein the metadata view renderer is configured to render a metadata user interface that allows a user to navigate between a thumbnail view, a keyword metadata view and a custom metadata view.

4. The system of claim 3, wherein the keyword metadata view displays a list of keywords that are associated with one or more segments of a video media asset, wherein a duration of each segment is defined by the difference in the timecode metadata for mark-in and mark-out frames associated with the keyword.

5. The system of claim 4, wherein the clip player user interface is rendered to have mark in and mark out buttons that allow a user to select starting and ending frames of a clip segment, respectively, during a playback of a low-resolution proxy clip to add a new keyword which is rendered to presentation to a user in the keyword metadata view.

6. The system of claim 5, wherein the starting frame of a clip segment is selectable by a user by selecting and dragging a first image frame displayed on the clip player user interface and dropping the selected first image frame onto the mark in button, and wherein the ending frame of a clip segment is selectable by a user by selecting and dragging a second image frame displayed on the clip player user interface and dropping the selected second image frame onto the mark out button.

7. The system of claim 2, wherein the thumbnail images of a media asset displayed on the storyboard user interface are graphical objects that can be selected and dragged to a thumbnail icon region of the metadata user interface and dropped on the thumbnail icon region to change the thumbnail icon off the media asset to the selected storyboard image.

8. The system of claim 2, wherein the thumbnail images of a media asset displayed on the storyboard user interface are graphical objects that can be selected to initiate the playing of a low resolution proxy video of the media asset at the frame associated with the selected storyboard thumbnail image.

9. The system of claim 2, wherein the thumbnail images of a media asset displayed on the storyboard user interface can be modified by selecting and dragging a video frame displayed by the clip player user interface to the storyboard user interface and dropping the selected video frame onto the displayed storyboard.

10. The system of claim 2, wherein any one of the synchronized user interface views can be controlled to generate a frame-accurate subclip of a video media by selecting mark in and marl out frames of the video media asset.

11. A method, comprising:
selecting a visual representation from media content utilizing an asset management user interface; and
associating the selected visual representation with a user-specified portion of the media content.

12. The method of claim 11 further comprising:
extracting metadata from a media asset and generating low-resolution media content objects representative of the media asset including frame-accurate thumbnail images of one or more frames of the media content;
storing metadata and low resolution media content objects in association with corresponding media assets; and
accessing and managing stored media assets through a plurality of synchronized user interfaces, including a metadata user interface that displays metadata associated with a media asset and allows user manipulation and editing of the metadata, wherein the metadata user interface displays a thumbnail image that is representative of the media asset, a storyboard user interface that displays a sequence of thumbnail images of selected frames of the media asset and allows user manipulation and editing of the storyboard and a clip player user interface that allows a user to play and manipulate a frame-accurate low-resolution proxy of the media asset, wherein user actions in manipulating and editing a media assets in one graphical user interface is synchronized over all views.

13. The method of claim 12 further comprising:
rendering the metadata user interface to allow a user to navigate between a thumbnail view, a keyword metadata view and a custom metadata view.

14. The method of claim 13 further comprising:
rendering the keyword metadata view to display a list of keywords that are associated with one or more segments of a video media asset, wherein a duration of each segment is defined by the difference in the timecode metadata for mark-in and mark-out frames associated with the keyword.

15. The method of claim 14 further comprising:
rendering the clip player user interface to display mark in and mark out buttons that allow a user to select starting and ending frames of a clip segment, respectively, during a playback of a low-resolution proxy clip to add a new keyword which is rendered to presentation to a user in the keyword metadata view.

16. The method of claim 15 further comprising:
allowing user selection of a starting frame of a clip segment by selecting and dragging a first image frame displayed on the clip player user interface and dropping the selected first image frame onto the mark in button, and allowing user selection of an ending frame of a clip segment by selecting and dragging a second image frame displayed on the clip player user interface and dropping the selected second image frame onto the mark out button.

17. The method of claim 12 further comprising:
rendering the thumbnail images of a media asset displayed on the storyboard user interface as graphical objects that can be selected and dragged to a thumbnail icon region of the metadata user interface and dropped on the thumbnail icon region to change the thumbnail icon off the media asset to the selected storyboard image.

18. The method of claim 12 further comprising:
rendering the thumbnail images of a media asset displayed on the storyboard user interface as graphical objects that can be selected to initiate the playing of a low resolution proxy video of the media asset at the frame associated with the selected storyboard thumbnail image.

19. The method of claim 12 further comprising:
rendering the thumbnail images of a media asset displayed on the storyboard user interface as graphical objects that can be modified by selecting and dragging a video frame displayed by the clip player user interface to the storyboard user interface and dropping the selected video frame onto the displayed storyboard.

20. The method of claim 12 further comprising:
controlling the user interface views in synchronization such that a frame-accurate subclip of a video media asset can be created by selecting mark in and mark out frames of the video media asset in any one of the views.
